(19) United States
(12) Patent Application Publication
(10) Pub. No.: US 2024/0189765 A1
(43) Pub. Date: Jun. 13, 2024

(54) SYSTEM AND METHOD FOR COMBINED ATMOSPHERIC WATER EXTRACTION AND CARBON CAPTURE

(71) Applicants: Benjamin Blumenthal, Dallas, TX (US); Patrick Furlotti, El Sequndo, CA (US)

(72) Inventors: Benjamin Blumenthal, Dallas, TX (US); Patrick Furlotti, El Sequndo, CA (US)

(21) Appl. No.: 18/230,435

(22) Filed: Aug. 4, 2023

Related U.S. Application Data
(60) Provisional application No. 63/395,185, filed on Aug. 4, 2022.

(51) Int. Cl. B01D 53/26; B01D 53/04; H01M 8/0656

(52) U.S. Cl. CPC B01D 53/265; B01D 53/0438; B01D 53/261; H01M 8/0656; B01D 2221/16; B01D 2257/504; B01D 2257/80

(57) ABSTRACT

Systems and methods for combined atmospheric water extraction and atmospheric carbon capture are provided. Fan(s) are adapted circulate ambient air to one or more atmospheric water extraction devices and atmospheric carbon capture devices. Water extracted from the atmosphere is heated to produce steam, which is used to release carbon absorbed by the atmospheric carbon capture devices for use in carbon storage and/or fuel production. The system may be powered by renewable energy sources. Water extracted from the atmosphere also undergoes electrolysis to isolate hydrogen, such as for use in fuel production.

### CROSS-REFERENCE TO RELATED APPLICATIONS

This application claims the benefit of U.S. Provisional Application Ser. No. 63/395, 185 filed Aug. 4, 2022, the disclosures of which are hereby incorporated by reference as if fully restated herein.

### TECHNICAL FIELD

Exemplary embodiments of the present disclosures relate generally to systems and methods for combined atmospheric water extraction and atmospheric carbon capture, such as for electrolysis and methanol generation.

### BACKGROUND AND SUMMARY OF THE INVENTION

Traditionally, potable water (H₂O), including by way of example and not limitation, drinking water, is obtained from surface freshwater, groundwater sources, and/or desalinated from brackish or seawater. In many developed communities in the post-industrial era, the water obtained from such sources needs to be purified or distilled to remove contaminants before it is usable by industrial processes or as drinking water. However, a significant amount of electricity is required to operate such treatment facilities. In some areas of the world, there are limited or no practical access to water from these sources. For example, by way of illustration and not limitation, communities in arid areas such as deserts, or on small islands may have a limited freshwater supply, and overpopulated areas may lack adequate mechanisms for supplying everyone with potable water.

The recent development of atmospheric water extraction has provided an alternative mechanism for obtaining potable water, which may be beneficial to individuals and communities lacking access to potable water from such sources. Atmospheric water extraction generally involves collecting water vapor from ambient air, and condensing the water vapor into liquid form, such as by, for example not by way of limitation, cooling the air, introducing desiccants, pressurizing the air, some combination thereof, or the like. An issue with atmospheric water extraction is that a substantial amount of electricity may be required to operate atmospheric water extraction devices and machinery, and thus current atmospheric water extraction may involve a relatively high carbon footprint.

In the industrial and post-industrial eras, anthropogenic emissions of carbon dioxide (CO₂) and other greenhouse gasses on a massive scale in connection with fossil fuel combustion for energy production has led to an increase in the amount of infrared radiation retained by the atmosphere. As a result, global temperatures have increased, and global climate patterns have been altered, with a number of adverse impacts on both humans and a number of other different organisms. At current atmospheric CO₂ levels, global temperatures may continue to increase and global climate patterns may continue to be altered. Thus, it is desirable to remove CO₂ from the atmosphere on a large scale.

An emerging practice is carbon sequestration, which, generally speaking, involves capturing CO₂ from the atmosphere or other sources of high concentrations of carbon dioxide through a number of different processes. Carbon sequestered from the atmosphere is typically stored as biomass or organic matter in soil, is injected directly into geologic formations or the deep ocean, or is chemically treated to form carbonates. An issue with carbon sequestration is that it is generally costly, and the act of storing carbon in of itself is typically not profitable unless a government or other individual or entity subsidizes and/or offers financial incentives therefore, such as subsidies, tax credits, or the like. As a result, a significant amount of government spending may be required to advance carbon sequestration.

The aforementioned shortcomings speak to the need for atmospheric carbon capture practices that are more cost efficient in nature, and for water extraction practices that have less negative anthropogenic effects on the environment. Particularly, it would be beneficial to have water extraction practices that are carbon neutral or carbon negative in nature, and to have carbon capture practices that are profitable, potentially independent of government spending or other subsidization.

In view of this, it is beneficial to have a combined system and method for both water extraction and carbon capture. The present disclosures provide systems and methods for combined removal of carbon dioxide (CO₂) from the atmosphere, extraction of water (H₂O) from the atmosphere, and utilization of extracted CO₂ and H₂O for storage, sales for profit, subsequent fuel production, some combination thereof, or the like. Preferably, one or more substantially renewable energy supplies are utilized for operating the disclosed systems and methods.

In exemplary embodiments, without limitation, an air intake system is adapted to cause ambient air to enter and thereafter flow through an exemplary air flow network. The ambient air may pass through at least one inlet and air filter of the air intake system before being transported through exemplary air ducts, tubes, hoses, some combination thereof, or the like of the exemplary air flow network. The exemplary air flow network may be maintained within at least one combined water extraction and carbon capture facility. The air flow network may direct a first airflow path from the air intake system to one or more exemplary atmospheric water extractors or generators, and a second airflow path from the air intake system to one or more exemplary atmospheric carbon absorbers. Alternatively, the air flow network may direct an airflow path initially to one of the atmospheric water extractor(s) or carbon absorber(s), and then subsequently to the other of the atmospheric water extractor(s) or carbon absorber(s). The ambient air may be directed through the at least one inlet and air filter of the air intake system by one or more fans. The water extraction and carbon capture facility may be located in an area with a consistent and substantial degree of wind flow, including by way of example and not limitation, substantially uninhabited or rural terrestrial areas in the path of prevailing winds, coastal or offshore (marine) areas in the path of prevailing winds, polar areas, or the like.

The one or more exemplary atmospheric water extractors or generators may comprise one or more refrigerant-based water extractors (where air is cooled to cause water molecules to condense to liquid form), salt or desiccant-based water extractors, such as by way of example and not limitation, a desiccant wheel, some combination thereof, or the like. Desiccant-based water extractors may provide the advantage of being adapted to readily absorb and/or adsorb moisture from air flowing therethrough or in proximity thereto, and of further being adapted for heating to release absorbed or adsorbed water as steam. Adsorption of atmospheric water may continue until the atmospheric water extractor is fully saturated. Atmospheric water extraction may be particularly advantageous in areas where the freshwater supply is scare, and/or access to potable water distribution systems is limited, including by way of example and not limitation, deserts and other arid landscapes, offshore installations, scarcely inhabited areas, heavily inhabited areas with poor or inadequate potable water distribution mechanisms, or the like. The air flow for the atmospheric water generation 26 subsystem may be separate from or integrated with the air flow for the carbon capture subsystem 38.

The one or more exemplary atmospheric carbon absorbers may comprise one or more porous substrates, including by way of example and not limitation, blocks comprising polymer resins, silica, metal oxides, some combination thereof such as ceramic, or the like. Amine adsorbents (adsorbents comprising an ammonia derivative), may be bonded to portions of the substrate(s), such as pores thereof, such as by covalent bonding. Airflow of the exemplary air flow network may be directed through or in close proximity to the atmospheric carbon absorber. CO₂ contained in the airflow may be adsorbed or covalently bonded to the amine adsorbents throughout the carbon absorber, and thus CO₂ may be absorbed by the carbon absorber until amine adsorbents are fully saturated with carbon. When an atmospheric water extractor and/or carbon absorber becomes fully saturated, a central control unit (referred to herein as “control unit”) may cause airflow to the water extractor(s) and/or carbon absorber(s) to temporarily cease. The control unit may further cause an amount of liquid water to be transported away from the water extractor(s) for subsequent storage and/or uses. The control unit may also direct a heater to elevate the temperature of an amount of extracted atmospheric water to produce steam therefrom.

The steam may be directed to pass through, or in proximity to, the carbon absorber(s) to release significant concentrations of purified CO₂ towards a CO₂ isolation unit. In some embodiments, a heater is adapted to heat the carbon absorber(s) to promote CO₂ release. In some embodiments, without limitation, a master heating system directs heat to each of the water extractor(s) and carbon absorber(s). CO₂ discharged from the carbon absorber(s) may be cooled and directed to pass through the CO₂ isolation unit. The CO₂ isolation unit may be a condenser adapted to separate residual water vapor and droplets from CO_{2,} and to direct volumes of each water and CO₂ to respective, isolated downstream flow paths. An amount of isolated H₂O from atmospheric water extraction, residual steam, a condenser, some combination thereof, or the like may be directed to potable water storage, may be transported to consumers, may be directed to one or more electrolysis devices, some combination thereof, or the like. An amount of isolated CO₂ may be directed to storage. Another amount of isolated CO₂ may be directed to a fuel production unit, including by way of example and not limitation, a catalytic reactor. It is not necessarily required that all steam for releasing CO₂ from carbon absorber(s) be derived from atmospheric water extraction. Amounts of steam may also be derived from an independent water supply, particularly when more water than available from atmospheric water extraction is desired to cause CO₂ release.

One or more electrolysis devices may be provided for isolating pure, or substantially pure, hydrogen from water. The electrolysis devices may be adapted to receive an amount of water extracted from the atmosphere. An amount of current may be directed through the water in an electrolysis device to isolate hydrogen from oxygen. An amount of isolated O2 may be directed to storage. An amount of isolated H2 may be directed to storage and/or directed to any number of different subsequent uses, directed to the fuel production unit, sold as a fuel for fuel cells, some combination thereof, or the like. In certain embodiments, a fuel production unit comprises a liquid methanol generator having a condenser and catalytic reactor. An exemplary liquid methanol generator (also referred to herein as a “methanol production unit”) may involve combining purified CO₂ released from the carbon absorber(s) with isolated hydrogen from electrolysis to form liquid methanol. Liquid methanol may be stored and/or transported for subsequent uses as combustible fuel, may be further refined into other fuels or chemicals, such as gasoline, diesel, DME, formaldehyde, acetic acid, some combination thereof, or the like. Methanol may be useful as an industrial chemical and/or as a multi-purpose fuel. By way of example and not limitation, methanol may be converted into gasoline, olefins, some combination thereof, or the like. This may be particularly useful in the modern era of relatively high traditional fuel prices and the need for alternative fuels. The use of liquid methanol may provide relatively high energy density and/or easy transport.

The control unit may be adapted to regulate each step of any aforementioned process for efficiency. Any number of different algorithms, sensors, Al systems, location detection and adjustment mechanisms, or the like may be configured to optimize atmospheric water extraction, atmospheric carbon capture, steam production, purified CO₂ release, separation of CO₂ and H₂O, electrolysis, fuel production (e.g., methanol production), some combination thereof, or the like. Any aforementioned process may be powered substantially by renewable energy, including by way of example and not limitation, solar energy, wind energy, tidal and/or wave energy, some combination thereof, or the like. In exemplary embodiments, without limitation, the combined water extraction and carbon capture facility is located in close proximity to one or more renewable energy sources, such as, but not limited to, windfarms (onshore or offshore), solar power facilities, hydroelectric power facilities, or geothermal power facilities, combinations thereof, or the like, and may receive a substantial portion of its required electricity therefrom. The facility may, alternatively or additionally, receive a substantial portion of its required electricity from tidal or wave energy. Alternatively, or additionally, a plurality of solar panels may be positioned in close proximity to the combined water extraction and carbon capture facility, and the facility may receive a substantial portion of its required electricity therefrom. Such embodiments may be particularly useful in areas having both little cloud cover and scare fresh water, including by way of example and not limitation, deserts. Power sources that generate continuous power supply are preferred over power sources that provide periodic power, such as solar only providing power during the day, or wind farms providing power only when it is windy, though such is not necessarily required.

While the disclosed devices, systems, and methods may occupy a relatively large footprint in practice, they may not require certain dedicated external infrastructure (e.g., water supply, carbon supply, etc.) in certain exemplary embodiments, without limitation. Particularly where renewable energy sources are utilized, this may permit the creation of fuel from, essentially, ambient environment. This may aid in placement of the disclosed devices, systems, and methods is normally less accessible locations and/or without the need for certain supporting infrastructure.

Further features and advantages of the systems and methods disclosed herein, as well as the structure and operation of various aspects of the present disclosure, are described in detail below with reference to the accompanying figures.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a flow chart with an exemplary method of combined water extraction and carbon capture;

FIG. 2 is a flow chart with an exemplary method of combined water extraction and carbon capture, operable on the system of FIG. 3;

FIG. 3 is a simplified system diagram for the combined water extraction and carbon capture, operable with the method of FIG. 2;

FIG. 4 is a simplified system diagram for an exemplary renewable energy framework for use with any aforementioned method or system; and

FIG. 5 illustrates an exemplary system for processing carbon dioxide and hydrogen into methanol.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

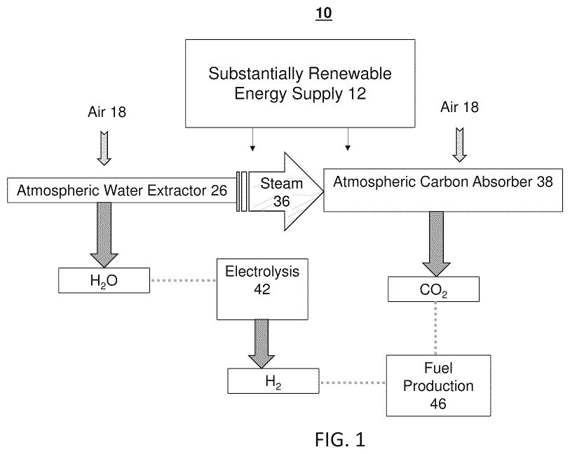

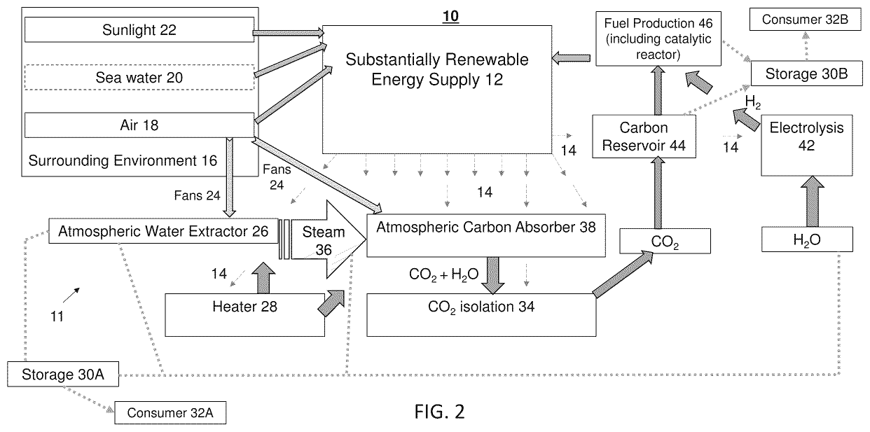

Referring now to FIGS. 1-2, exemplary methods 10 for water extraction and carbon capture are illustrated. Here, the system 10 is powered by one or more substantially renewable energy supplies 12, though such is not required. The substantially renewable energy supply 12 may involve turbines, photovoltaic cells, some combination thereof, or the like, which may be actuated by energy from sunlight 22, sea water 20, air 18, hydroelectric power sources (e.g., dams), geothermal heat, ocean heat differences, wave motion, some combination thereof, or the like from the surrounding environment 16 to generate electricity 14 for a water extraction and carbon capture facility 11. Wind motion of ambient air 18, electricity (e.g., 14), some combination thereof, or the like may drive motion of one or more fans 24 of the system 10. The fans 24 may cause circulation of air through or in close proximity to any number of different devices of the water extraction and carbon capture facility 11. By way of example and not limitation, the fans 24 may direct an amount of air to at least one atmospheric water extraction subsystem (also referred to herein as an atmospheric water extractor) 26 and an amount of air to at least one atmospheric carbon capture subsystem (also referred to herein as an atmospheric carbon absorber) 38. This air flow could be separately or serially provided to the atmospheric carbon capture subsystem 38 and the atmospheric water generation system 26.

The atmospheric carbon absorber subsystem 38 may be configured to absorb an amount of CO₂ from air flowing therethrough and/or in close proximity thereto. The atmospheric water extractor subsystem 26 may be configured to extract an amount of H₂O from air flowing therethrough and/or in close proximity thereto. A heater 28 may be configured to heat water extracted by the atmospheric water extractor 26 to produce steam 36. The steam 36 may be introduced to the atmospheric carbon absorber 38 to release purified CO₂ therefrom. An amount of air comprising released CO₂ and steam/water vapor may be directed from the atmospheric carbon absorber 38 to one or more CO₂ isolation units 34 adapted to isolate CO₂ from H₂O, such as by way of example and not limitation, H₂O in residual steam exiting a carbon absorber 38. A CO₂ isolation unit 34 may include by way of example and not limitation, a condenser. CO₂ may be directed from the CO₂ isolation unit 34 to one or more CO₂ storage tanks and/or other carbon reservoirs 44. Additionally, or alternatively, CO₂ may be directed to a fuel production unit 46. In certain exemplary embodiments, without limitation, CO₂ is combined with hydrogen (e.g., H₂) for fuel production 46, including by way of example and not limitation, methanol production and/or butanol production. The hydrogen (e.g., H₂) may be derived from electrolysis 42, which may involve isolating hydrogen from oxygen in water, such as water directly sourced from the atmospheric water extractor(s) 26 and/or a stored water supply 30A thereof, water derived from residual steam 36, condensed residual water derived from the carbon absorber(s) 38 and/or CO₂ isolation unit 34, an independent water supply, some combination thereof or the like. Preferably, an amount of water employed for electrolysis 42 is sourced from the atmospheric water extractor(s) 26, and may be transported therefrom to an electrolysis 42 device by pipes, hoses, ducts, tubes, other channels, some combination thereof, or the like. The hydrogen produced by the electrolysis subsystem can be directed toward fuel (such as methanol) generation system, stored, or sold as fuel for fuel cells.

CO₂ and/or derivative fuels may be transported for storage 30B and/or consumption 32B. Amounts of liquid water may be collected during, or in close temporal proximity to, any of atmospheric water extraction, steam 36 introduction, CO₂ isolation 34, some combination thereof, or the like. Collected water may be stored 30A, including by way of example and not limitation, in one or more storage tanks, transported for consumption 32A, some combination thereof, or the like. Collected hydrogen may be stored, including by way of example and not limitation, in one or more storage tanks, transported for consumption 32A, some combination thereof, or the like.

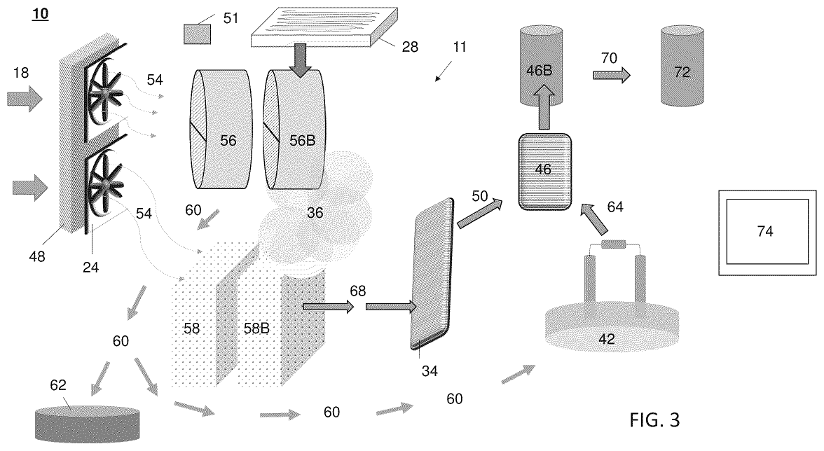

Referring now to FIG. 3, the exemplary system for water extraction and carbon capture 10 may include one or more air intake systems (e.g., 24, 48). The air intake system may include a number of fans 24 adapted to direct ambient air 18 to enter and thereafter flow through an air flow network 54 of a facility for water extraction and carbon capture 11. The ambient air 18 may pass through at least one inlet and air filter 48 of the air intake system before being transported through one or more air ducts, tubes, hoses, some combination thereof, or the like of the air flow network 54. The air filter 48 may be configured to prevent, for example not by way of limitation, particulates above a certain size and/or of a certain type, which may otherwise be present in the ingested atmospheric air, from entering the air flow network 54. In exemplary embodiments, without limitation, the air flow network 54 directs a first airflow path from the air intake system to one or more exemplary atmospheric water extractors 56, and a second airflow path from the air intake system to one or more atmospheric carbon absorbers 58. In other embodiments, an exemplary air flow network may direct an airflow path initially to one of the atmospheric water extractor(s) or carbon absorber(s), and then subsequently to the other of the atmospheric water extractor(s) or carbon absorber(s).

Alternatively, or additionally, the system 10 may rely on ambient wind without the need for fans 24 or continuous operation of the fans 24. For example, without limitation, the fans 24 may be reduced in speed and/or turned off where measured wind speed is above a predetermined threshold(s). Control of the fans 24 in this regard may be made by one or more electronic controllers 74, which may be in electronic communication with one or more sensors 51 (e.g., windspeed) or electronic information sources for the same.

Ingested ambient air may be provided at room temperature (e.g., between 15-30° C.) and standard atmospheric pressure (e.g., 0.5-1.5 atm). One or more temperature sensors 51 may be provided at the intake, in the surrounding environment, and/or within the airflow network 54 to measure characteristics of the ambient air (e.g., temperature, pressure, windspeed, moisture content, particulate content, etc.). Reading from the sensors 51 may be take periodically, continuously, randomly, combinations thereof, or the like. Any type, kind, and/or number of sensors 51 may be provided in any arrangement. The sensors 51 may be in electronic communication with the controller(s) 74, which may comprise one or more electronic storage devices, processors, computer devices, combinations thereof, or the like. Ambient air not ingested at preferable temperatures, pressures, or other characteristics may be treated (e.g., heated, permitted to expand, filtered, combinations thereof, or the like) to meet preferable operating conditions before being ingested or further passed through the system 10.

Referring now to FIGS. 2-3, ambient air may be ingested continuously and/or periodically, such as until saturation or other predetermined threshold is reached at the carbon absorber subsystem 38 and/or atmospheric water extractor subsystem 26. For example, airflow may be resumed where the same or different thresholds are reached at the carbon absorber subsystem 38 and/or atmospheric water extractor subsystem 26 indicating a lack of saturation. Such determination may be made at the controller 74 by way of one or more sensor 51 readings. Louvers, fan 24 speed, or other control systems may be operated by the controller 74 to close or open intakes into the system 10, increase and/or decrease ambient air ingestion, combinations thereof, or the like. Other criteria used to determine air ingestion may include, for example without limitation, storage capacity, fuel or other by product production, combinations thereof, or the like. Louvers, fans 24, or other control mechanisms may be provided at any number of locations along the airflow network 54.

In certain exemplary embodiments, without limitation, the combined water capture and carbon extraction facility 11 is located in area with a consistent and substantial degree of wind flow, including by way of example and not limitation, substantially uninhabited or rural terrestrial areas in the path of prevailing winds, including by way of example and not limitation, westerly winds and northeast trade winds, coastal or offshore areas in the path of prevailing winds, polar areas, or the like. Electrically powered fans and wind flow independently or in combination may supply ambient air to an exemplary air intake system. Any number of other different devices or mechanisms for supplying ambient air to an exemplary air intake system may be utilized. By way of example and not limitation, a solar heating tower may provide for air temperature gradients yielding convective air movement, which may cause circulation of air through an air flow network.

The exemplary system 10 of FIG. 3 further includes at least one atmospheric water extractor subsystem 56. The atmospheric water extractor subsystem 56 may comprise a refrigerant-based water extractor, desiccant-based water extractor, some combination thereof, or the like. In exemplary embodiments, without limitation, the atmospheric water extractor 56 comprises a desiccant wheel. The desiccant wheel 56 may include each of an adsorption region adapted to receive ambient air, such as at room temperature and pressure, and desorption region adapted to store and/or discharge regenerate water. The desiccant wheel 56 may be adapted to rotate to cycle different portions of the wheel 56 between the adsorption region and the desorption region. Alternating different portions of the wheel 56 between the adsorption region and the desorption region may promote increased extraction of water from air flowing through or in close proximity to the wheel 56 by allowing for saturated portions of the wheel 56 to be alternated with non-saturated portions of the wheel to extend the extraction process. Any number of different motors, actuators, or the like may be configured to cause rotation of an exemplary desiccant wheel.

The desiccant wheel 56 may comprise any suitable porous solid material embedded with hygroscopic material, including by way of example and not limitation, silica, silica gel, alumina, alumina gel, activated carbon, sodium salts, potassium salts, magnesium salts, hydrophilic polymers, combinations thereof, or the like. The hygroscopic material may be adapted to condense water vapor into liquid regenerate water. An amount of the liquid regenerate water may be stored in or in close proximity to the desiccant wheel 56. An amount of the liquid regenerate water may be collected by a water collection apparatus and subsequently transported away 60 from the desiccant wheel 56, such as to, by way of example and not limitation, a freshwater storage tank 62, an electrolysis device 42, some combination thereof, or the like. The flow 60 of the liquid regenerate water from the water collection apparatus to some location away from the desiccant wheel 56 may be caused by gravity, one or more pumps, pressure gradient(s), some combination thereof, or the like.

Adsorption of atmospheric water may continue until the atmospheric water extractor is fully saturated (e.g., 56B), a certain amount of water has been extracted, a certain volume of air has passed through or in close proximity to the atmospheric water extractor 56, some combination thereof, or the like. Saturation may be determined by one or more of the sensors 51. In exemplary embodiments, without limitation, when there is saturation of the atmospheric water extractor 56B, the extractor 56B is heated by a heater 28 to release steam 36 from the extractor 56B. Operation of the heater 28 may be controlled by the controller 74. Any number, type, and/or arrangement of thermal units or other devices or mechanisms for heating water extracted from the atmosphere to produce steam may be utilized. Steam production may be performed outside of the extractor 56B. For example, without limitation, extracted water may be transported away from the atmospheric water extractor 56 to a steam production unit for production of steam, for example. Steam production may, alternatively or additionally, be provided from other water sources, such as where needed for supplementing purposes. By way of example and not limitation, sea water may, alternatively or additionally, be heated for steam production, and precipitate salts therefrom may be utilized for the production of hygroscopic material to be embedded in desiccant-based atmospheric water extractors.

Desiccant wheels or other desiccant-based atmospheric water extractors are not necessarily required. Any number of different atmospheric water extractors may be employed. By way of example and not limitation, a refrigerant based atmospheric water extractor may involve cooling air in the atmospheric water extractor to temperatures below a dew point temperature to cause water molecules to condense to liquid form. A controller 74 may be adapted to communicate to the atmospheric water extractor dew point temperature necessary to achieve condensation based on the relative humidity measured for air in or in close proximity to the atmospheric water extractor. Relative humidity of air introduced to the atmospheric water extractor may be measured by one or more sling psychrometers, which may be one of the sensors 51, in electronic communication with the controller 74, and dew point may be calculated according to the following equation:

Ts=(b×α(T, RH))/(a−α(T, RH))

In the aforementioned equation, Ts represents calculated dew point temperature, T represents initial air temperature (e.g., measured by a thermometer), RH represents measured relative humidity of the air (e.g., measured by a sling psychrometer), “a” and “b” represent Magnus coefficients (a=17.62; b=243.12), and a represents α=In (RH/100)+a*T/(b+T). The refrigerant based atmospheric water extractor may be set to a temperature at or below the calculated dew point temperature to form condensation to be collected by a water collection apparatus. Cooling of the refrigerant based atmospheric water extractor may be achieved, at least in part, by a cooling system using sea water. An amount of sea water may be withdrawn from the ocean and returned thereto after sensible heat from the atmospheric water extractor is transferred to the sea water. Cooling of the refrigerant based atmospheric water extractor may also be achieved, at least in part, by a cooling system using ambient air where sensible heat is transferred from the atmospheric water extractor to said ambient air. One or more heat exchangers may be introduced to an exemplary cooling system to promote sensible heat transfer.

The exemplary system 10 of FIG. 3 may also comprise one or more carbon absorber subsystems 58. The carbon absorber 58 may comprise one or more sorbent structures comprising one or more porous substrates. By way of example and not limitation, the sorbent structure may be a block comprising polymer resins, silica, metal oxides, some combination thereof such as ceramic, or the like. In certain embodiments, pore diameters range from 10 nm-1 μm. The pores may permit air to flow through the sorbent structure. Amine adsorbents may be bonded to portions of the substrate(s), such as pores thereof, such as by covalent bonding. By way of example and not limitation, amine adsorbents may include aziridine, amino silanes, or the like. A porous alumina coating may be introduced to the surface of the sorbent structure for embedding amine adsorbents thereto. Covalent bonding, by way of example and not limitation, may be achieved by ring-opening polymerization of aziridine on porous and non-porous supports, reacting mono-di and/or tri-amino silanes with silica or a metal oxide having hydroxyl surface groups, some combination thereof, or the like. Any number of different known techniques for embedding amine adsorbents in a porous substrate may be utilized.

Airflow of the exemplary air flow network 54 may be directed from fans 24 to the carbon absorber 58 by way of air ducts, tubes, hoses, some combination thereof, or the like. An amount of airflow may be directed through or in close proximity to the atmospheric carbon absorber 58 to contact sorbent material thereof. In certain exemplary embodiments, without limitation, a number of sorbent structures (e.g., 58, 58B) having a relatively large surface area compared to thickness are vertically oriented and placed in close parallel proximity to one another (e.g., 1 mm-1 cm apart). The sorbent structures (e.g., 58, 58B) may be positioned substantially perpendicular to the direction of air flow to maximize the volume of air exposed to each unit area of each sorbent structure, though any orientation may be utilized. The sorbent structures (e.g., 58, 58B) may be adapted to be alternated between a first position in a pathway of the airflow network 54, and a second position in the pathway of steam 36 flow. By way of example and not limitation, said alternation of sorbent structure position may be caused by a mobile platform, a pulley system, some combination thereof, or the like. Alternatively, the sorbent structures (e.g., 58, 58B) may be substantially stationary, and the control unit 11 may be adapted to alternate airflow pathways directed towards the sorbent structures (e.g., 58, 58B) between ambient air (e.g., from 54) and steam 36 flow, for example.

CO₂ contained in the ambient airflow (e.g., from 54) may be adsorbed or covalently bonded to the amine adsorbents throughout the carbon absorber 58 as air passes therethrough. The sorbent structure may continue to bind CO₂ until it reaches a specific saturation level, measured CO₂ downstream of the sorbent structure reaches a specific concentration, some combination thereof, or the like. When an atmospheric water extractor and/or carbon absorber becomes fully saturated, and/or a threshold downstream CO₂ concentration is reached, the control unit 74 may cause airflow to the water extractor(s) and/or carbon absorber(s) to temporarily cease for steam stripping of the carbon absorbers(s).

Amine adsorbents may be reintroduced as necessary to the carbon adsorber(s) 58 when a decrease in CO₂ removal efficiency of the carbon absorber(s) is detected. By way of example and not limitation, a mass spectrometer, which may be one of the sensors 51, may be configured to measure CO₂ levels in air downstream of the carbon absorber(s) (e.g., 58, 58B), and may communicate the measurements to the control unit 74. The control unit 74 may be configured to determine if CO₂ levels downstream of the carbon absorber(s) have increased over time, and thus determine if degradation of amine absorbents has occurred. Alternatively, or additionally, one or more sensors 51 may be adapted to detect if amines are present in liquid water collected from the carbon absorber(s) during and/or after steam 36 stripping. The presence of amines in said liquid water may indicate that degradation of amine absorbents has occurred, and reintroduction of amine absorbents to the carbon absorber(s) is desirable.

Amines embedded in solid substrates for CO₂ removal are not necessarily required. By way of example and not limitation, liquid alkaline solution absorbents based on amine or carbonates may also be employed for atmospheric carbon capture. A number of amines and/or carbonates may be added to an amount of water extracted from the atmosphere to form the alkaline solution. CO₂ from air introduced to the solution may be selectively absorbed, resulting in a CO₂ rich solution, which may be subsequently heated to remove purified CO₂ therefrom, and filtered and/or otherwise treated to remove purified liquid water therefrom.

The exemplary system 10 of FIG. 3 also comprises one or more thermal units (e.g., heater 28) adapted to elevate the temperature of an amount of extracted atmospheric water to produce steam 36 therefrom. Steam 36 may be produced at relatively low temperatures, such as by way of example and not limitation, temperatures between 100-130° C. The steam 36 may be directed from the heated extracted atmospheric water source through an air flow pathway isolated from the air flow network 54 and other sources of air ingress, such as by way of ducts, pipes, hoses, tubes, containers, some combination thereof, or the like. One or may fans 54 may be configured to direct the aforementioned air flow pathway. The steam 36 may be directed by said pathway to pass through or in proximity to the carbon adsorbers 58, 58B to promote desorption and release of CO₂ downstream 68 from the carbon adsorbers 58, 58B. Specifically, energy from the temperature swing provided by the steam 36, together with a partial pressure driving force provided by the steam 36, may be sufficient to break the amine-CO₂ bonds in the carbon absorbers 58, 58B, and yield a high CO₂-concentration volume of air (“purified CO₂”) downstream 68 of the carbon absorbers 58, 58B. The aforementioned process may be referred to herein as “steam stripping.” Steam stripping may be executed in a well-insulated container adapted to maintain desired air volumes, pressures, and temperatures, and to prevent water vapor and/or CO₂ from escaping. In some embodiments, steam stripping occurs for 10-30 minutes. In some embodiments, carbon absorbers themselves may be directly heated by a thermal unit to contribute to the temperature swing, independent of, or in addition to steam stripping.

An amount of steam and/or water vapor may also be released downstream of the carbon adsorbers 58, 58B. Thus, air substantially comprising CO₂ and H₂O may be directed (e.g., 68) from the carbon adsorbers 58, 58B to a CO₂ isolation unit 34, including by way of example and not limitation, a condenser, in an air flow pathway isolated from the air flow network 54 and other sources of air ingress, such as by way of ducts, pipes, hoses, tubes, containers, some combination thereof, or the like. One or may fans may be configured to direct the aforementioned air flow pathway. In some embodiments, a master heating system controlled by control unit 74 directs heat to each of the water extractor(s) and carbon absorber(s). In exemplary embodiments, the steam 36 utilized for stream stripping of the carbon absorbers 58, 58B is sourced from water extracted from the atmosphere. The water extractor itself may be heated to produce steam 36, and/or an amount of water may be removed from the water extractor and subsequently heated to produce steam 36. In other exemplary embodiments, without limitation, an amount of steam may also be generated from heating liquid water introduced from another source, such as the ocean, some other body of water, water tanks, a domestic water supply, some combination thereof, or the like. Deriving an amount of steam from a non-atmospheric water supply may be useful when more water than available from atmospheric water extraction is desired to generate steam for CO₂ release.

In certain embodiments, the CO₂ isolation unit 34 includes a condenser adapted to receive and cool air 68 from the air flow pathway leading from the carbon absorbers 58, 58B to condense and separate water and other molecules from CO₂ gas, as applicable. Cooling of the air received by the condenser CO₂ isolation unit 34 may be achieved by decreasing the temperature within the CO₂ isolation unit 34 to a temperature below that of the dew point (but high enough to maintain CO₂ in gas form) for the air received in order to form condensation of water within the CO₂ isolation unit. Dew point may, in exemplary embodiments, be measured by one or more of the sensors 51 and reported to the controller 74 to adjust thermal operations accordingly. The controller 74 may be adapted to communicate to the CO₂ isolation unit 34 dew point temperature necessary to achieve condensation based on the relative humidity measured for air entering the CO₂ isolation unit 34. Relative humidity of air entering the CO₂ isolation unit 34 may be measured by a sling psychrometer, which may be one of the sensors 51, in communication with the controller 74, and dew point may be calculated according to the following equation, by way of example:

Ts=(b×α(T, RH))/(a−α(T, RH))

In the aforementioned equation, Ts represents calculated dew point temperature, T represents initial air temperature (e.g., measured by a thermometer), RH represents measured relative humidity of the air (e.g., measured by a sling psychrometer), “a” and “b” represent Magnus coefficients (a=17.62; b=243.12), and α represents α=In (RH/100)+a*T/(b+T).

Suitable condensers may comprise polymers, metals, some combination thereof, or the like. Condensers may comprise a number of coils, fins, plates, tortuous passages, some combination thereof, or the like. Condensers may be cooled, at least partially, by the transfer of sensible heat from the condenser to cooling fluid such as sea water, ambient air, some combination thereof, or the like, wherein the cooling fluid may be adapted to transport heat away from the condenser. Condensers may also be cooled, at least partially, by one or more electric cooling devices. One or more heat exchangers may also be introduced in proximity to the condenser(s) to contribute to temperature regulation thereof. It will be apparent to one of ordinary skill in the art that there may be any number of different methods or devices available for isolating CO₂ from water vapor, water droplets and other molecules in air flowing from an exemplary carbon absorber after steam stripping thereof. A condenser of CO₂ isolation unit 34 may also be adapted for pressure alteration therein to contribute to water condensation. Volumes of each CO₂ gas and liquid water may subsequently be directed to respective, isolated downstream flow paths. By way of example and not limitation, an amount of liquid water may be directed from the CO₂ isolation unit 34 to potable water storage 62, the electrolysis device 42, some combination thereof, or the like.

Additionally, or alternatively, in certain embodiments, an amount of CO₂ released from the carbon absorber(s) 58, 58B may be directed to flow through one or more washing devices to recover any possible amines present therein. In certain preferred embodiments, CO₂ gas is condensed to liquid form by cooling (e.g., below 0° C.) and pressurizing (e.g., above 73 atm). The aforementioned condensing of CO₂ may be achieved in the CO₂ isolation unit, may be achieved in a separate device for CO₂-specific condensing, some combination thereof, or the like.

Any number of different water collection devices and pathways may be employed. In exemplary embodiments, without limitation, water collection devices provide for water flow 60 from the atmospheric water extractors 56, 56B to the water storage unit 62 and the electrolysis device 42. It will be apparent to one of ordinary skill in the art that water for use in storage, transportation, electrolysis, steam production, some combination thereof, or the like may be derived from any number of different steps or devices of an exemplary embodiment. By way of example and not limitation, condensed water from steam flowing through the carbon absorbers 58, 58B may also be collected, although this water may require a sufficient degree of subsequent testing and treatment to ensure that negligible impurities such as, by way of example and not limitation, amines and/or dissolved CO₂ are present therein. Water 60 may be transported to water storage 62, such as a water tank, and may be subsequently transported to any number of different consumption points, storage points, and/or additional transportation points. The water 60 may be treated after collection to ensure potability thereof, such as by way of example and not limitation, by filtration, disinfection (e.g., UV disinfection), some combination thereof, or the like. In certain embodiments, an amount of collected water may be recycled towards the heater 28 for subsequent steam production.

An amount of isolated CO₂ (e.g., 50) may be directed to storage, a fuel production unit (e.g., 46), including by way of example and not limitation, a methanol production unit, a transportation vessel, some combination thereof, or the like. An amount of CO₂ may be sequestered using any number of different known carbon sequestration techniques, such as for example not by way of limitation, injecting the CO₂ into geologic formations such as oil and gas reservoirs, un-minable coal seams, deep saline reservoirs, deep bed rock caverns, some combination thereof, or the like. An amount of CO₂ may also undergo mineral sequestration by being introduced to, for example not by way of limitation, calcium and magnesium silicates.

The electrolysis device 42 may be adapted to direct an amount of current through water to isolate hydrogen from oxygen. By way of example and not limitation, H₂ may be generated by pressurized alkaline electrolysis operating at 30 bar in a 30 MW electrolysis unit (e.g., described in Nieminen, H., Laari, A., and Koiranen, T. (2019). CO₂ Hydrogenation to Methanol by a Liquid-Phase Process with Alcoholic Solvents: A Techno-Economic Analysis. Processes, 7(7), 405) (referred to herein as “Nieminen et al.”). Water molecules may be split by the electrolysis device 42 to form an equal amount of hydrogen in moles.

The pure hydrogen 64 may thereafter be introduced to a fuel production unit 46, such as a methanol generator, which may comprise a condenser and a catalytic reactor positioned downstream of the electrolysis unit 42. Hydrogen 64 may be combined with CO₂ to form methanol, butanol, some combination thereof, or the like according to known techniques. An exemplary fuel production unit may include any number of different condensers and catalytic reactors. An exemplary catalytic reactor may comprise any number of different devices permitting one or more catalysts to enable catalytic reactions. The catalytic reactor may be adapted to regulate reaction heat, mass transfer, some combination thereof, or the like. A constant supply of hydrogen may be provided to the fuel production unit to permit steady-state operation at design capacity.

In certain embodiments, methanol is produced from gas-phase methanol synthesis according to known methods (e.g., described in Nieminen et al.). In such embodiments, a catalytic reactor at the fuel production unit 46 may be adapted to cause gas comprising hydrogen, CO and CO₂ to be converted into methanol on copper and zinc oxide-based catalysts at temperatures of 200-300° C. and pressures of 50-100 bar. The methanol synthesis processes may be described according to the following equilibrium reactions:

| | | |
|---|---|---|
| CO₂ + 3H₂ [symbol] CH₃OH + H₂O | ΔH⁰ = −49.8 kJ/mol | (1) |
| CO₂ + 2H₂ [symbol] CH₃OH | ΔH⁰ = −91.0 kJ/mol | (2) |
| CO + H₂O [symbol] CO₂ + H₂ | ΔH⁰ = −41.2 kJ/mol | (3) |

Equations (1) and (2) may represent the exothermic hydrogenation of CO₂ and CO to methanol, and equation (3) may represent a water-gas shift reaction that may be activated by copper-based methanol synthesis catalysts. Reactions (1) and (2) preferably occur at relatively low temperatures and high pressures. Reactant H₂ may be derived from electrolysis 42 of water extracted from the atmosphere, and Reactant CO₂ may be derived from atmospheric carbon capture, resuspension and isolation, such as described above for certain exemplary embodiments. In other embodiments, methanol may be produced by directly hydrogenating pure CO₂ with H₂ with high selectivity using conventional copper and zinc oxide-based catalysts. In other exemplary embodiments, without limitation, one or more of the equations (e.g., 1-3) may be practiced in reverse. For example, without limitation, CO₂+H₂ [symbol] CO+H₂O.

In other embodiments, without limitation, methanol is produced from liquid phase methanol synthesis according to known methods (e.g., described in Nieminen et al.). By way of example and not limitation, alcohol solvents (e.g., 2-butanol and 1-butanol) may be combined with conventional copper and zinc oxide-based catalysts to permit methanol synthesis reactions to occur at lower temperatures. As another example not by way of limitation, inert hydrocarbon solvents may permit effective heat control of the exothermic reactions for methanol synthesis. It will be apparent to one of ordinary skill in the art that there may be any number of different methods, devices and/or materials available for producing methanol using carbon dioxide and hydrogen as reactants without departing from the scope of the present invention.

Liquid methanol may be stored (e.g., 46B) and/or transported for subsequent uses such as for use as combustible fuel, may be transported 70 to a refinery 72 for gasoline production according to known techniques, some combination thereof, or the like. In certain embodiments, an amount of combustible fuel derived from CO₂ extracted by the system 10 is utilized to satisfy, at least in part, the power requirements of the system 10. By way of example and not limitation, an amount of butanol derived from captured, resuspended and isolated CO₂ combined with hydrogen from electrolysis may be produced in the fuel production unit 46, and may be used to contribute to power requirements of the system 10.

The control unit 74 may be adapted to regulate each step of any aforementioned process for efficiency. Any number of different algorithms, sensors 51, Al systems, location detection and adjustment mechanisms, or the like may be configured to optimize atmospheric water extraction, atmospheric carbon capture, steam production, purified CO₂ release (e.g., 68), separation of CO₂ and H₂O, electrolysis, methanol production, some combination thereof, or the like. Any aforementioned process may be powered substantially by renewable energy, combustible fuels derived from CO₂ extraction, some combination thereof, or the like.

The control unit 74 may be configured to regulate the flow rate of air flow 54 directed to the water extraction device 56 according to a calculated water extraction efficiency. For example, not by way of limitation, a flow sensor 51 adapted to measure the amount of water discharged from the water extraction device 56 may communicate amounts of water discharged over time to the control unit 74, and the control unit 74 may organize discharge data according to time of day, month, weather patterns or characteristics, some combination thereof, or the like. The control unit 74 may direct flow rate of air flow 54 directed to the water extraction device 56 to increase or decrease based on historical extraction efficiency data to promote extraction of a desired amount of water. Extraction efficiency may be calculated according to the following equation:

EE=ΔHᵥₐₚH₂O (mass of liquid water produced÷heat energy required by the system to produce the mass of liquid water).

In the aforementioned equation, EE represents extraction efficiency, and ΔHᵥₐₚH₂O represents the heat of vaporization of water. In this particular example, extraction efficiency is represented as a percentage. By way of example and not limitation, when the control unit 74 determines that the extraction efficiency or other goal is below a desired threshold percentage or other value, fan 24 speed may be increased to increase the amount of air flow to the atmospheric water extractor 56.

The control unit 74 may further be configured to regulate air flow (e.g., 54) directed to the atmospheric carbon absorbers 58, 58B based on measured CO₂ concentration downstream 68 of the atmospheric carbon absorbers. By way of example and not limitation, a mass spectrometer, which may be one of the sensors 51, may be configured to measure CO₂ concentration of air 68 collected downstream of the atmospheric carbon absorbers 58, 58B and communicate said concentration to the control unit 74. The control unit 74 may be adapted to compare said concentration of air 68 collected downstream of the atmospheric carbon absorbers 58, 58B with a desired CO₂ concentration threshold for said air 68. Accounting for margin of error and statistical significance, when the concentration of CO₂ in air 68 collected downstream of the atmospheric carbon absorbers 58, 58B is lower than said desired CO2 concentration threshold, air flow (e.g., 54) to the carbon absorbers 58, 58B may be increased by the control unit 74. Any number of different control units 74 may be utilized and comprise one or more processors, electronic storage devices, executable software instructions, and the like.

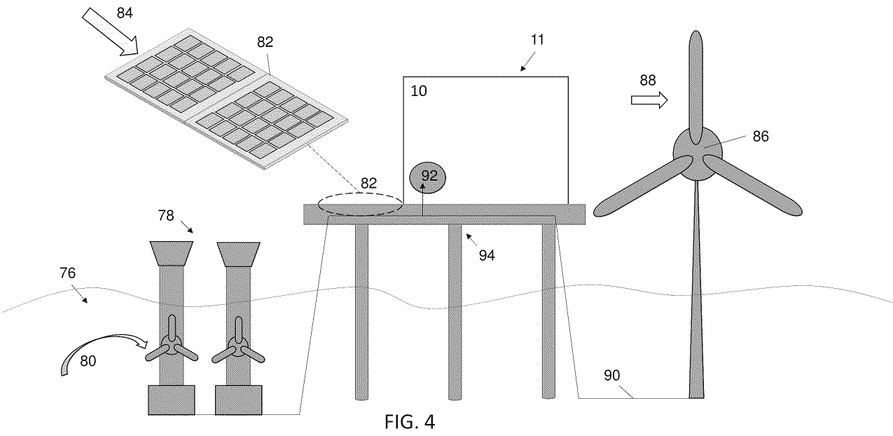

Referring now to FIG. 4, an exemplary facility 11 for the combined water extraction and carbon capture system 10 is illustrated in proximity to several renewable energy devices 78, 82, 86 adapted to provide electricity to the facility 11. In this particular embodiment, the facility 11 is positioned over the ocean 76 at an offshore installation 94. The renewable energy devices may include one or more tidal or wave energy devices 78. The tidal or wave energy devices 78 are configured with turbines adapted to receive fluid force 80 from wave motion, water current, water level fluctuations, some combination thereof, or the like, and rotate upon receiving said fluid force 80. An alternator may transform the mechanical energy of the rotation into electricity, and said electricity may be delivered to an electricity input 92 of the facility 11 by way of cable, conduit, wire, power/transmission line (e.g., 90), some combination thereof, or the like.

A plurality of solar panels 82 may also be positioned in proximity to the facility 11, and may be in electronic communication therewith by way of power/transmission lines (e.g., 90), cable, conduit, wire, some combination thereof, or the like. Each solar panel 82 may comprise a number of photovoltaic cells and semiconducting materials adapted to transform energy from the sun 84 into electricity. Additionally, one or more wind mills 86 may be positioned in proximity to the facility 11. The wind mill 86 may be configured with turbines adapted to rotate when blades linked thereto rotate when acted upon by wind 88. An alternator may transform the mechanical energy of the rotation into electricity, and said electricity may be delivered to the electricity input 92 by way of cable, conduit, wire, power/transmission line (e.g., 90), some combination thereof, or the like. The renewable energy devices 78, 82, 86 may substantially power any number of different devices of the facility 11.

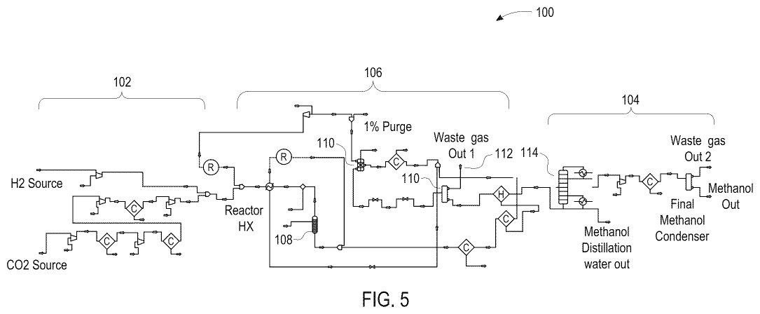

FIG. 5 illustrates an exemplary methanol generation system and process 100 that combines hydrogen provided by the electrolysis subsystem 42 and carbon dioxide from the carbon capture subsystem 38 into methanol. Table 1 provides typical values at various points around the system 100 by way of example, without limitation.

TABLE 1

| Object | Waste Gas Out 2 | Waste Gas Out 1 | Reactor Output | |
|---|---|---|---|---|
| Temperature | 41.825 | 34.2824 | 270.756 | |
| Pressure | 1.2 | 1.2 | 77.4294 | |
| Mass Flow | 0.86634 | 6952.37 | 314146 | |
| Mass Flow (Mixture)/Methanol | 0.040968 | 1680.9 | 61660.5 | |
| Mass Flow (Mixture)/Water | 9.59678E−06 | 211.209 | 34490.1 | |
| Mass Flow (Mixture)/Carbon dioxide | 0.395328 | 4317.92 | 95814.3 | |
| Mass Flow (Mixture)/Carbon | 0.0190659 | 259.483 | 25875 | |
| monoxide | | | | |
| Mass Flow (Mixture)/Hydrogen | 0.0422565 | 482.861 | 96306.3 | |
| Reactor Input | Methanol Out | Methanol Distillation Water Out | Methanol Condenser 2 Liquids | |
| 210 | 47.0433 | 102.302 | 34.2824 | |
| 77.7 | 1.2 | 1.1 | 1.2 | |
| 314146 | 59266 | 33862.2 | 93129 | |
| 1226.86 | 59262 | 0.0792139 | 59262.5 | |
| 342.946 | 3.76566 | 33862.1 | 33865.9 | |
| 179232 | 0.180801 | 2.50863E−16 | 0.57613 | |
| 25612.6 | 0.00871971 | 5.18205E−15 | 0.0277856 | |
| 107732 | 0.0279711 | 1.59823E−17 | 0.0702275 | |
| Methanol Condenser 2 Inlet | Methanol Condenser 1 Liquids | Methanol Condenser 1 Inlet | | |
| 34.2824 | 35 | 35 | | |
| 1.2 | 73.7274 | 73.7274 | | |
| 100081 | 100081 | 314776 | | |
| 60943.4 | 60943.4 | 61746.1 | | |
| 34077.1 | 34077.1 | 34525.9 | | |
| 4318.5 | 4318.5 | 95966.6 | | |
| 259.511 | 259.511 | 25951.1 | | |
| 482.932 | 482.932 | 96586.3 | | |
| Methanol Condenser 1 Gases | H2 Source | CO2 Source | 1% Purge | Units |
| 35 | 25 | 25 | 35 | C |
| 73.7274 | 30 | 1.01325 | 73.7274 | bar |
| 214695 | 12100 | 88000 | 2146.95 | kg/h |
| 802.699 | 0 | 0 | 8.02699 | kg/h |
| 448.837 | 0 | 0 | 4.48837 | kg/h |
| 91648.1 | 0 | 88000 | 916.481 | kg/h |
| 25691.6 | 0 | 0 | 256.916 | kg/h |
| 96103.4 | 12100 | 0 | 961.034 | kg/h |

To meet formatting requirements, Table 1 is provided in multiple parts, but is intended to be interpreted as a continuous table. For example, the second row indicates exemplary temperature values in degrees Celsius across the several columns corresponding to several points of the process 100. The values provided by Table 1 are non-limiting example.

Overall, the process 100 inputs (generally indicated at item 102) are generally noted on the left side and the process 100 outputs (generally indicated at item 104) are generally noted on the right side of FIG. 5. In the generally middle space is an exemplary generation loop (generally indicated at item 106) for the process 100. The generation loop 106 may be utilized so that reagents involved may be passed through the reactor(s) 108 multiple times, because the methanol generation process may be reversible. The process 100 inputs, such as but not limited to hydrogen and carbon dioxide, may be utilized to charge the generation loop 106. A methanol separator 110 may remove the created methanol and water. A waste valve 112 may be remove excess gases and may be selectively controlled to maintain overall loop 106 pressure. The loop 106 may produce excess waste heat, which may be used to preheat the reagents for the reactor 108, and/or to heat the methanol/water mix prior to reaching the distillation column 114 by way of non-limiting example. On the generally right side include multiple stages of distillation that may be used to purify the methanol by removing the water and entrained gases.

The process 100 inputs may both compress and heat the incoming streams. In exemplary embodiments, without limitation, 12100 kg/hr of hydrogen may be delivered at 25 C and 30 bar. 88000 kg/hr of carbon dioxide may be delivered at 25 C and 1 bar. Both streams may be compressed to 78 bar prior to injection into the loop 106. The compression process may create heat in both streams. These streams may be pressurized in steps and/or intercooled to reduce energy requirements. The process 100 may compress the hydrogen stream all at once, requiring 6900 kW of electricity and heating the hydrogen to 164 C. The carbon dioxide may be compressed in four stages with intercooling, by way of non-limiting example. Each of the four stages may require about 2500 kW of electricity. Each of the 3 intercoolers may release about 2500 kW of waste heat between 135 and 40 C. At the end, the CO2 may be injected at 78 bar and 155 C. These are non-limiting examples.

Starting at the injection point, the loop 106 may include a flow of 314000 kg/hr at 59 C with 91% H2, 1.5% CO, 6.9% CO2, and less than a tenth of a percent of methanol and water, all by mole fraction. This flow may be heated to 210 C by a regenerative heat exchanger. The flow may then pass through the reactor 108. After the reactor 108 the mole fraction of the stream may be changed to 87% H2, 1.7% CO, 4% CO2, 3.5% H2O, and 3.5% methanol. The stream may also be heated to 271 C. These are non-limiting examples.

At this point the flow may be split, with most of the flow going to one or more regenerative heaters. In this heater(s) the reactor's output at 271 C may be cooled to 90 C, heating the incoming flow as described. After reactor output is cooled in the regenerative heater(s) it may be sent to the methane condenser 110. These are non-limiting examples.

The other, potentially smaller portion of the flow leaving the reactor 108 may be cooled to 156 C. This process 100 may release approximately 22150 kW of waste heat as the flow cools. This flow may then pass through the Methanol Distillation Column 114 heat exchanger, cooling to 79 C and producing 22100 kW of waste heat, before rejoining the first flow on the way the methane condenser 110. This may represent a large source of high temperature waste heat. Typically, this waste heat may be directed towards the atmospheric water generation 26 and/or air capture subsystem 38 of the Atmospheric Methane process 100. These are non-limiting examples.

The methane condenser 110 may operate at 74 bar and 35 C. This may force the methane and water to condense and separate. To cause this condensation, 45000 kW of thermal energy may be released between 85 C and 35 C. This may represent a large source of low temperature waste heat. The separated liquid, mostly water and methanol, may be directed toward a second methanol condenser 100 and may be provided at approximately 100000 kg/hr. At this point the separated liquid may be 46% methanol, 46% water, 2.4% CO2, 5.8% H2, and 0.2% CO, by mole fraction. The separated gases may include a 215000 kg/hr flow, including 94% H2, 1.8% CO, 4.1% CO2, and <1% methanol and water. A waste valve 112 may allow the escape of about 1% of this flow to control the accumulation of waste gases resulting from secondary reactions not modeled. The separated gases may be recompressed to 78 Bar, which may heat them to 42 C prior to reaching the injection point and starting the loop 106 again. These are non-limiting examples.

The second methane condenser 110 may be held at 1.2 bar, so the separated liquid has its pressure reduced prior to entry. This pressure reduction may cause the methanol and water to flash, reducing the gas entrainment concentrations to near zero. The second methane condenser 110 may be at about 35 C. The separated gases, another waste gas stream of 6950 kg/hr may include about 58% H2, 2.3% CO, 24% CO2, 3% water, and 13% methanol, by mole fraction. The separated liquid may include a stream of 92100 kg/hr, which may include 50% methanol and 50% water, with only trace amounts of CO, CO2, and H2. This separated liquid, on the way to the methanol distillation column 114, may be heated in a heat exchanger to 80 C by the second part of the loop 106. These are non-limiting examples.

The methanol distillation column 114 may be configured to separate the flow into one that is mostly water and the other that is mostly methanol. The water flow of 33900 kg/hr may be almost pure water. The methanol flow may include 59300 kg/hr of almost pure methanol. This flow may be further compressed and cooled in additional stages to remove the tiny amount of remaining entrained gases, if required to meet quality standards. These are non-limiting examples.

Locations in this system 100 where heat is removed in heat exchangers or condensers may be sources of waste heat that can be used to replace electric power requirements for the atmospheric water generation subsystem 26 and/or atmospheric carbon capture subsystems 38. The selection of a desiccant-based atmospheric water generation subsystem 26 and an adsorption-based atmospheric carbon capture system 38 may allow for the use of this waste heat as a replacement to electrical energy, thereby reducing overall energy consumption requirements, promoting efficiency, and/or reducing environmental impact.

By way of non-limiting example, the disclosed systems and methods may achieve a $400/ton levelized cost of methanol production, assuming otherwise baseline costs and conditions. 74% of this plants cost may be in the carbon capture subsystem 38. By utilizing a high-carbon exhaust stream, such as 10% CO2, the resulting levelized cost may be reduced to $250/ton. These values assume a 60000 ton per year plant for scale.

By way of non-limiting example, the disclosed systems and methods may be implemented in at least the following areas which may have favorable condition for implementation: Brazil, southern USA, Hawaii, Spain, Japan, Columbia, Chile, Norway, Sweden, Finland, Canada, India, Malaysia, Indonesia, Iceland, off-shore any of these locations or otherwise, combinations thereof, or the like. Of course, this list is merely exemplary.

The production numbers and/or examples provided herein, particularly as to the process 100, including the various subsystem, sub-steps, combinations thereof, or the like, are merely exemplary and are not intended to be limiting.

Any number, kind, and/or type of energy sources, renewable or otherwise, may be utilized.

One or more pumps, fans, passageways, combinations thereof, or the like may be utilized to provide fluid connection between one or more components described herein and/or provide transportation of one or more fluids (gaseous or liquid) between or more components. Valves or other flow control devices may be used to direct and control the flow of flids through the one or more passageways. The sensors 51 may be provided at or along the one or more passageways to measure one or more characteristics of fluids passing therethrough.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Certain operations described herein may be performed by one or more electronic devices. Each electronic device may comprise one or more processors, electronic storage devices, executable software instructions, and the like configured to perform the operations described herein. The electronic devices may be general purpose computers or specialized computing device. The electronic devices may comprise personal computers, smartphone, tablets, databases, servers, or the like. The electronic connections and transmissions described herein may be accomplished by wired or wireless means. The computerized hardware, software, components, systems, steps, methods, and/or processes described herein may serve to improve the speed of the computerized hardware, software, systems, steps, methods, and/or processes described herein.

What is claimed is:

1. A system for combined atmospheric water extraction and carbon capture, said system comprising:
an atmospheric water extractor subsystem;
an atmospheric carbon absorber subsystem in fluid communication with the atmospheric water extractor subsystem;
an airflow subsystem in fluid communication with the atmospheric water extractor subsystem and the atmospheric carbon absorber subsystem such that, when operated, the airflow subsystem is configured to ingest ambient air and cause said ingested ambient air to contact each of the atmospheric water extractor subsystem and the atmospheric carbon absorber subsystem;
a power supply subsystem electrically connected to the atmospheric water extractor subsystem, the atmospheric carbon absorber subsystem, and the airflow subsystem;
wherein the atmospheric water extractor subsystem is adapted to extract an amount of water from the ambient air contacting the atmospheric water extractor subsystem;
wherein the atmospheric carbon absorber subsystem is adapted to retain an amount of carbon dioxide from the ambient air contacting the atmospheric carbon absorber subsystem; and
wherein the atmospheric carbon absorber subsystem is adapted to utilize at least some of the amount of water extracted from the atmospheric water extractor to regenerate carbon dioxide from the atmospheric carbon absorber subsystem.

2. The system of claim 1 further comprising:
a control unit in electronic communication with atmospheric water extractor subsystem, the atmospheric carbon absorber subsystem, and the airflow subsystem and adapted to regulate a flow rate of the ambient air, and further adapted to prevent the ambient air from contacting either of the atmospheric water extractor subsystem and the atmospheric carbon absorber subsystem when either is saturated.

3. The system of claim 2, further comprising:
a number of sensors in electronic communication with the control unit and configured to measure characteristics of the ambient air comprising temperature, pressure, and composition, wherein the control unit is adapted to automatically regulate the flow rate of the ambient air based on a calculated extraction efficiency.

4. The system of claim 1, wherein:
the atmospheric water extractor subsystem comprises desiccants adapted to condense liquid water on the extractor.

5. The system of claim 1 further comprising:
a heater adapted to generate steam from a portion of the amount of water, wherein the atmospheric carbon absorber subsystem is configured to receive a portion of the steam to regenerate the carbon dioxide.

6. The system of claim 5 further comprising:
a condenser adapted to receive an amount of air flowing from the atmospheric carbon absorber subsystem, the amount of air comprising an amount of regenerated carbon dioxide and water vapor, wherein the condenser is further adapted to condense the water vapor to form liquid water, and separate the liquid water from the regenerated carbon dioxide.

7. The system of claim 5, wherein:
the atmospheric carbon absorber subsystem comprises a porous substrate having amines embedded thereon; and
the porous substrate having amines embedded thereon comprises a ceramic block.

8. The system of claim 6 further comprising:
a number of water collection apparatuses, each adapted to collect water from any of the atmospheric water extractor subsystem, the condenser and the atmospheric carbon absorber subsystem.

9. The system of claim 1, wherein:
the power supply subsystem comprises one or more of: a wind turbine, a tidal power generation device, a water turbine, and a solar cell; and
the airflow subsystem comprises one or more fans.

10. The system of claim 9, further comprising:
an offshore platform housing said atmospheric water extractor subsystem, said atmospheric carbon absorber subsystem, said airflow subsystem, and said power supply subsystem, wherein said atmospheric water extractor subsystem, said atmospheric carbon absorber subsystem, said airflow subsystem, and said power supply subsystem are self-contained within said offshore platform.

11. The system of claim 1, further comprising:
an electrolysis subsystem adapted to receive a portion of the amount of water and isolate hydrogen therefrom; and
a methanol production subsystem adapted to combine a portion of the amount of carbon dioxide with a portion of isolated hydrogen to form methanol.

12. A system for combined atmospheric water extraction and carbon capture, said system comprising:
an atmospheric water extraction subsystem adapted to extract an amount of water from ambient air;
an atmospheric carbon absorption subsystem adapted to retain an amount of carbon dioxide from the ambient air and comprising a porous substrate having amines embedded thereon;
an intake area;
a series of passageways fluidly interconnecting the intake area, the atmospheric water extraction subsystem, and the atmospheric carbon absorption subsystem;
an airflow subsystem comprising fans and filters configured to ingest and circulate the ambient air through the series of passageways to the atmospheric water extractor subsystem and the atmospheric carbon absorber subsystem;
one or more sensors located along one or more of the series of passageways for measuring characteristics of fluids passing therethrough;
a power supply subsystem comprising one or more of: a wind turbine, a tidal power generation device, a water turbine, a geothermal power device, an ocean thermal power device, grid power, a co-located power plant, and a solar cell, wherein the power supply subsystem is adapted to provide electrical power to the airflow subsystem, the atmospheric carbon absorption subsystem, and the atmospheric water extraction subsystem;
a heater configured to generate steam from a portion of the amount of water;
a condenser adapted to receive an amount of air from the atmospheric carbon absorber subsystem, the amount of air comprising an amount of regenerated carbon dioxide and water vapor; and
a controller in electronic communication with the airflow subsystem, the atmospheric carbon absorption subsystem, the atmospheric water extraction subsystem, the one or more sensors, and the heater, wherein the controller is adapted to regulate a flow rate of the ambient air through the series of passageways, and further adapted to prevent ambient air from contacting either of the atmospheric water extractor and the atmospheric carbon absorber when either is saturated as determined by measurements from the one or more sensors;
wherein the atmospheric carbon absorber is configured to receive a portion of the steam to regenerate carbon dioxide therefrom;
wherein the condenser is adapted to condense the water vapor to form liquid water, and separate the liquid water from the regenerated carbon dioxide.

13. The system of claim 12, further comprising:
an electrolysis device fluidly connected to the series of passageways and adapted to receive a portion of the amount of water and isolate hydrogen therefrom; and
a methanol production subsystem fluidly connected to the series of passageways and adapted to combine a portion of the amount of carbon dioxide with a portion of isolated hydrogen to form methanol.

14. The system of claim 13, further comprising:
a control system configured to measure temperature, pressure, and composition of flows in the methanol production subsystem and automatically adjust processes to maintain pressure at a reactor above 74 bar and temperatures at an inlet to the reactor above 210° C.

15. The system of claim 14, further comprising:
a waste heat recycling subsystem configured to use waste heat from the methanol production subsystem to supply thermal energy to one or more of: the atmospheric water extraction subsystem and the atmospheric carbon absorption subsystem.

16. A method for combined atmospheric water extraction and carbon capture, said method comprising:
circulating, by way of an airflow apparatus, ambient air to each of an atmospheric water extractor and an atmospheric carbon absorber;
extracting, by way of the atmospheric water extractor, to extract an amount of water from the ambient air;
retaining, by way of the atmospheric carbon absorber, an amount of carbon dioxide from the ambient air; and
causing an amount of water extracted from the atmospheric water extractor to regenerate carbon dioxide from the atmospheric carbon absorber.

17. The method of claim 16, further comprising:
regulating a flow rate of the ambient air by way of a central control unit;
preventing, by way of the central control unit, the ambient air from contacting either of the atmospheric water extractor and the atmospheric carbon absorber when either is saturated;
determining, by way of the central control unit, a calculated extraction efficiency;
regulating, by way of the central control unit, the flow rate of the ambient air based on the calculated extraction efficiency; and
collecting, by way of a number of water collection apparatuses, water from each of the atmospheric water extractor, the condenser, and the atmospheric carbon absorber.

18. The method of claim 16, further comprising:
providing an electrolysis device, and configuring the electrolysis device to receive a portion of the amount of water, and isolate hydrogen therefrom; and
combining a portion of the amount of carbon dioxide with a portion of isolated hydrogen, by way of a methanol production subsystem, to produce methanol.

19. The method of claim 16, further comprising:
powering one or more of the airflow apparatus, the atmospheric water extractor, and the atmospheric carbon absorber by way of one or more renewable energy sources.

20. The method of claim 16, further comprising:
utilizing an electrolysis device to receive a portion of the amount of water and isolate hydrogen therefrom;
storing the isolated hydrogen; and
dispensing the stored hydrogen as a fuel for fuel cells.
